(19) United States
(12) Patent Application Publication
(10) Pub. No.: US 2014/0084178 A1
(43) Pub. Date: Mar. 27, 2014

(54) Applying CRT tube-type electron directingplates in a double slit system to provide an observable bridge between classical and quantum physics

(71) Applicant: James D. Welch, Omaha, NE (US)

(72) Inventor: James D. Welch, Omaha, NE (US)

(21) Appl. No.: 13/998,521

(22) Filed: Nov. 8, 2013

Related U.S. Application Data
(60) Provisional application No. 61/961,236, filed on Oct. 9, 2013.

(51) Int. Cl. G21K 1/00

(52) U.S. Cl. CPC G21K 1/00
USPC 250/393; 250/423 R

(57) ABSTRACT

Applying a Double Slit System in combination with Cathode Ray Tube-type electron directing plates between which an electron travels on its way to the Slits, and to which plates are applied precise voltage potentials in use, allows controlling where, within the width of a Double Slit System Slit an electron passes, and perhaps enables predicting where on a Double Slit Screen a specific electron will impinge.

This application Claims benefit of Provisional 61/961,236, filed Oct. 9, 2013.

### TECHNICAL FIELD

The present invention relates to Quantum Double Slit systems, and more particularly is an approach of applying a Double Slit System in combination with Cathode Ray Tube-type electron directing plates between which an electron travels on its way to the Slits, to which plates are applied precise voltage potentials in use, thereby allowing controlling where, within the width of a Double Slit System Slit an electron passes, and thereby enhancing prediction of where, on a Double Slit Screen, a specific electron will impinge.

### BACKGROUND

Welch (1) (2) (3), has previously described an approach to gaining insight to which slit of a Double Slit system it is more probable that a photon or particle passes in the forming an Interference Pattern, (ie. he challenges conventional Momentum-Position Uncertainty). This approach relies on use of information available from inspection of the physical Double Slit system. And in a Paper titled “Is Heisenberg's Uncertainty Quantum Mechanic's Mathematical “Trick” to Account For Chaos Effects in Physical Systems” (4), ISAST Transactions on Computers and Intelligent Systems, No. 3, Vol. 3, it is proposed that Uncertainty as to where a photon or particle impacts a screen in a Double Slit System could be beneficially viewed as the result of Chaos effects at the Slits. The approach applies a laterally movable, but position resetable momentum transfer detecting Interference Pattern forming screen.

The Conventional approach, when considering results produced by a Double Slit system, involves viewing the Interference Pattern produced thereby as the most focused example there is for demonstrating the “mysteries” of Quantum Mechanics and in particular, the Uncertainty Principle. The author herein has adopted this view in previous articles (1) (2) (3), even while presenting proposals as to how the Uncertainty Principle supposedly being demonstrated could be challenged.

Continuing, in previous publication (4), an approach to understanding the results produced by a Double Slit system was also presented. It was proposed that the Double Slit system is not primarily demonstrating Quantum Mechanic's principles, but rather is simply providing a cross-sectional “snapshot” of a photon-wave or particle-wave combination as it propagates through a transition state between a photon-wave or particle-wave combination approaching Double Slits, and the same photon-wave or particle-wave combination which would appear far past the Double Slits, if the Double Slit system screen were not present. It is proposed that so viewed the “mystery” about where, in an Interference Pattern photons or particles impinge, is largely explained without resort to Heisenberg-type Uncertainty, but is better explained based on electromagnetic wave propagation principles.

In the identified papers, it was assumed that a source of a photon or particle causes a photon or particle to be launched toward and approach the Double Slits of a Double Slit system accompanied by an associated, (deBroglie wavelength (h/p)), electromagnetic wave with which said photon or particle is inseparably associated. The photon or particle was then viewed as passing through one of the slits at some location within the width thereof. The exact position at which the photon or particle passes through the slit varies from one photon or particle to the next because of chaos effects between the source and the Double Slit system. That is, even though the same initial conditions seemingly existed when a photon or particle is launched, slightly different photon or particle path trajectories toward the Double Slits result. And depending on the location within the width of a slit that a photon or particle passes, it is considered that it will often undergo a trajectory direction changing refraction as it emerges from said slit. However if this were the entire story, what would result would be a fairly uniform merger of two refraction patterns on the screen of the Double Slit system, and this is, of course, not what is observed in practice. There is seemingly, what the author has termed an “Attractor-like” effect in prior articles, which directs a photon or particle toward peaks in, and away from troughs in an actually realized Interference Pattern.

It is was proposed that the “Attractor” effect is actually no more than what is expected to occur based on the interaction between the wavelets that exit the two slits, which interaction creates an environment between the slits and the screen in a Double Slit system that presents the photon or particle with varying strength propagation fields along different slit refraction induced trajectory directions, based on constructive and destructive wavelet addition. In particular where destructive wavelet addition occurs, a photon-wave or particle-wave combination cannot propagate toward the Double Slit system screen, as the propagating wave is simply canceled and lost. That is, it was proposed that loss of a propagation affecting wave exists between the slits and the location on the screen upon which a trough region in the Interference Pattern forms, based on destructive wavelet addition. Likewise, it is proposed that constructive addition of wavelets occurs between the slits and a peak region of an Interference Pattern on said screen, which encourages a particle or photon to propagate there-toward.

Based on the foregoing, it was suggested that analysis of Double Slit system Interference Pattern formation might be better approached based on Maxwell's equations than on Schrodinger's equation, as formation of the Interference Pattern is more the result of wave propagation effects than it is of a Quantum Uncertainty relationship. To the author's knowledge this approach has not been previously reported And, if correct, this implies a serious question as to if the Double Slit system is actually demonstrating Quantum Uncertainty effects at all. Or perhaps whether Heisenberg's principle is a mathematical “trick” to account for, and even over-account for Chaos effects in physical systems, when analyzed by the Quantum Mathematics formalism.

As a more specific explanation, it was considered that a photon-wave or particle-wave combination exits a slit of a Double Slit system along a refraction affected trajectory that if continued would lead to impingement at a peak of an Interference Pattern on a screen placed past the slits. It is proposed that if the screen were not present that photon-wave or particle-wave would propagate along that trajectory indefinitely because wavelets from the slit through which the photon-wave or particle-wave combination did not pass, constructively add with the wavelet more directly associated with the photon or particle, (when they exited a slit together), thereby strengthening the propagation of the photon or particle along that trajectory. If, on the other hand, the photon-wave or particle-wave were directed by refraction effects at the slit through which it passed, to embark along a trajectory that encountered 180 degree out-of-phase wavelets from the slit through which the photon-wave or particle-wave did not pass, then the photon or particle would be left without a wave to encourage it to proceed to proceed. Such a photon or particle would then simply cease to move along that trajectory and hence would never arrive at what is a trough region on an Interference Pattern on a screen placed after the slits. That is, it is not that wavelets arriving at that trough region of a formed Interference Pattern are 180 degrees out of phase at that point, (as is at least implied by conventional presentations on the topic), it is rather that far earlier in the scenario the wave associated with a photon or particle when it left the slit it did, was canceled by a destructively interfering wavelet from the slit of the Double Slit system through which the photon or particle did not pass. That being the case, said photon or particle cannot propagate toward the screen. Of course, photons or particles launched toward regions between a peak and trough in an Interference Pattern would encounter varying degrees of cancellation. And in this light, it is expected that there will be far more such photon or particle impingements between peaks and troughs on screens placed relatively closely to the slits, than on screens placed further and further away therefrom, because their capacity for propagation will be diminished as compared to those that will continue to impinge at peaks locations, even at very large distances from the slits.

Finally, it was noted in (4) that the approach disclosed would still not enable precise prediction of where a particular photon or particle will arrive at in a forming Interference Pattern, but the “mystery” as to why that is the case is reduced to simply not being able to strictly control where, within the width of a slit in a Double Slit system, a photon or particle passes on its way to impacting the screen, via a refraction effect. Further, which slit a photon or particle passed through will also still not be known, however, see references (1-3) which describe an approach to increasing the probability of knowing which slit was the more likely. Therein it is proposed that if a photon or particle contributes to a positive/negative slope region in an Interference Pattern, then it is more likely to have passed through the left/right slit, as viewed from the photon or particle source. In what follows herein an approach to overcoming the identified shortcomings is described, involving controlling where an electron passes within a Double Slit System Slit width.

### REFERENCE AND BIBLIOGRAPHY

1. “The Uncertainty of Uncertainty”, ISAST Transactions on Computers and Intelligent Systems, No. 2, Vol 2, 2010 (ISSN 1798-2448).
2. “The Welch Certainty Principle”; ISAST Transactions on Computers and Intelligent Systems Systems, No. 1, Vol. 3, 2011 (ISSN 1798-2448).
3. “The Welch Certainty Principle Continued—Near Simultaneous Measurement of Position and Momentum”; ISAST Transactions on Computers and Intelligent Systems, No. 2, Vol. 3, 2011, (ISSN 1798-2448).
4. “Is Heisenberg's Uncertainty Quantum Mechanic's Mathematical “Trick” to Account For Chaos Effects in Physical Systems”, ISAST Transactions on Computers and Intelligent Systems, No. 3, Vol. 3, 2011, (ISSN 1798-2448).

### DISCLOSURE OF THE INVENTION

The present invention is a system comprising a source of electrons, a barrier having two slits therein and a screen, said system further comprising two plates placed between said source of electrons and said bather to which, in use, voltage potentials can be applied therebetween, said system components being arranged such that, in use, an electron emitted by said source thereof approaches said bather by passing through said two plates to which a voltage potential is applied therebetween, then pass through a slit, at a position within the width thereof determined by the voltage potential applied between said plates, and impact said screen

The present is also a method of enhancing the ability to predict where within a quantum double slit system a specific electron impacts a screen therein, comprising the steps of:

a) providing a double slit system comprising a source of electrons, a barrier having two slits therein of known widths and a screen, such that in use an electron is emitted by said source of electrons, proceeds to pass through a slit in the bather and impact the screen with the result being that an interference pattern is formed thereupon; said double slit system further comprising two plates positioned between said source of electrons and the barrier having two slits therein, such that in use voltage potentials can be applied therebetween so that when an electron passes between said plates its trajectory toward the barrier containing the two slits is modified, thereby allowing its position within a slit through which it passes to be controlled;
b) while applying a known voltage potential between said plates located between said source of electrons and said barrier containing two slits, causing a single electron to be emitted and directed toward said barrier containing two slits such that it passes between said two plates positioned between said source of electrons and said barrier containing two slits, such that said electron passes through a slit at a controlled location within; and impacts said screen and noting the location on said screen where it impacts;
c) repeating step b with a second electron and noting where on said screen the electron impacts;
d) comparing the results in steps b) and c).

The present invention also comprises a method of under the direction of a computer, directing a charged particle to an impact location with a screen in a double slit system that comprises, in sequence, a source of charged particles, a barrier in which are present two slits and said screen, said method comprising:

a) accessing a charged particle from said source thereof and causing it to approach said barrier in which are present said two slits along an intended trajectory affected by causing it to pass between two charged particle directing plates, across which plates is applied a voltage;
b) allowing the charged particle to pass through one of the two double slit system slits which are present in said barrier, and proceed to impact said screen;
said impact location with said screen being influenced by the voltage level applied to said charged particle directing plates.

Said method can further involve, under control of said computer, repeating said steps a) and b) using a sequential plurality of charged particles, with the same voltage applied to said charged particle directing plates as was previously applied, and using said compute comparing monitored locations as to where the plurality of charged particles impact said screen with the result being that said sequential plurality of charged particles are more tightly grouped than would be expected by application of the uncertainty principle.

It is also noted that any improvement in the ability to predict where, in a full Interference Pattern on a Double Slit Screen a specific particle (eg. electron), impinges, would provide a major advance in Physics. Thus, it is proposed that even an improved statistically based predictability would be significant. For instance, if a bias were applied to electron director plates that caused electrons, one by one, to approach a Slit at a far lateral extent thereof so that sometimes an electron impacted the barrier that contains the Slit and sometimes it went through the Slit very near said lateral extent thereof, it might become clear that the electrons that passed through the Slit, at said far lateral edge thereof, had a very high probability of impacting the Screen in a reduced regional location of the full Interference Pattern. See FIG. 2 Slit (S1) herein for example, which condition shown would be affected by applying a + voltage to the ungrounded Plate, (note, the Grounded Plate is to be understood to also include a Plate to which can be applied a Potential above or below ground), a electron Directing Plate and would provide a situation wherein it be very unlikely that the indicated electron passing through said Slit (S1) would ever contribute to an Interference Pattern to the right of center of the Slits (S1) and (S2). That improvement in predictability alone would be extremely significant, and would provide a correlation between applied electron directing Plate Voltage, (a Classical Physics parameter), and where an electron is more likely to impact the Double Slit Screen, (a Quantum Physics parameter). This is mentioned as voltages applied to the electron Director Plates are subject to an uncertainty and will not be precisely achieved at exact values in practice. But, the point is, an observable “broad-brush” effect would be enough to provide a significant advance in providing a bridge between Classical and Quantum Physics.

As a final consideration in this Section of the Specification, it is noted that Reference 3 in the Background Section discloses that if the Double Slit Screen, upon which the Interference Pattern forms, is allowed to move laterally in use, (with resetting of original position between impacts), then one can monitor both position of impact and get a nearly simultaneous indication of momentum at the time of that impact by monitoring the movement of the Screen, coupled with knowledge of the particle, (eg. electron), involved and the Screen masses. If one can control through which Slit the particle passed by applying electron Directing Plate Voltage, the resulting procedure can be seen to be capable of essentially “solving” the “mystery” associated with the Double Slit System. This analysis, of course, assumes that the particle involved remains a particle from the time it leaves the Source thereof, to the time it impacts the Double Slit Screen. And, it is noted that many Quantum people object to this, seemingly arguing that a particle morphs into a wave after leaving the Source thereof, passes through both Slits, and then re-morphs back into a particle when it impacts said Double Slit Screen. In this disclosure it is held that the particle (eg. electron), remains a particle throughout and passes through a single Slit. It is considered that a moving particle has an inseparable wave associated therewith which does pass through both Slits and guides where the particle, (eg. electron), can progress to on said Double Slit Screen so that an Interference Pattern is formed.

The present invention will be better understood by reference to the Detailed Description Section of this Specification, with reference to the Drawings.

### BRIEF DESCRIPTION OF THE DRAWINGS

FIG. 1 show a typical Cathode Ray Tube (CRT) system, including electron directing plates between which are applied various potentials so as to directing an electron passing there-between to intended locations on a CRT Screen. This is demonstrative of how old TV's operate.

FIG. 2 shows the electron directing plates as in FIG. 1 applied to direct an electron passing there-between to a location within the width of a Slit (S1) (S2) of a Double Slit system.

FIG. 3 is included to provide better insight as to how adjusting the potential between the electron directing plates would affect the position of the electron in the width of the Slit through which it passes.

FIGS. 4a-c are included to show to what the identifier (M0), (M1) etc. refer.

FIG. 5 is included to show constructive and destructive addition of wavelets after the Slits, shown separated by a distance -d- therein.

### DETAILED DESCRIPTION

It is suggested herein that placing a conventional Double Slit System into a Cathode Ray configuration that conventionally allows directing an electron, as a charged particle, to an intended location on a Cathode Ray Tube Screen, could allow directing an electron to a precise location in the width of a selected Slit in a Double Slit containing barrier placed between a cathode ray system electron gun and the associated cathode ray system screen. Controlling where within a slit an electron passes could substantially eliminate Chaos effects which, it is suggested, are actually responsible for the uncertainty as to where an electron impacts a screen in a Double Slit System.

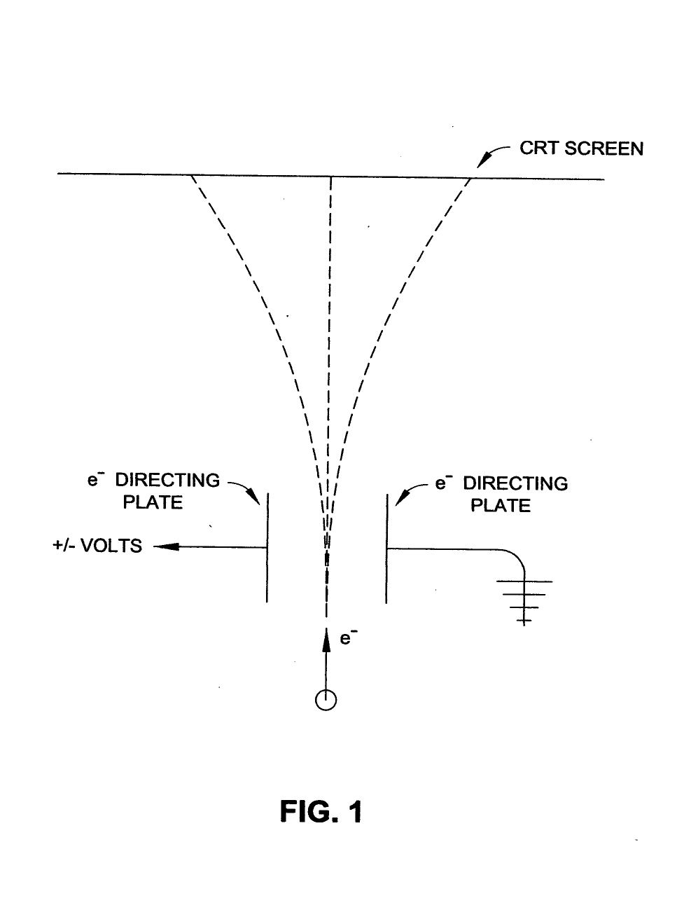

As additional insight, FIG. 1 show a typical Cathode Ray Tube (CRT) system, including electron directing plates between which are applied various potentials so as to directing an electron passing there-between to intended locations on a CRT Screen. This is demonstrative of how old TV's operate. Applying a + Voltage to the ungrounded Plate will attract the electron passing between the Plates to the left in FIG. 1, and applying a − Voltage to said ungrounded Plate will force the electron to the right.

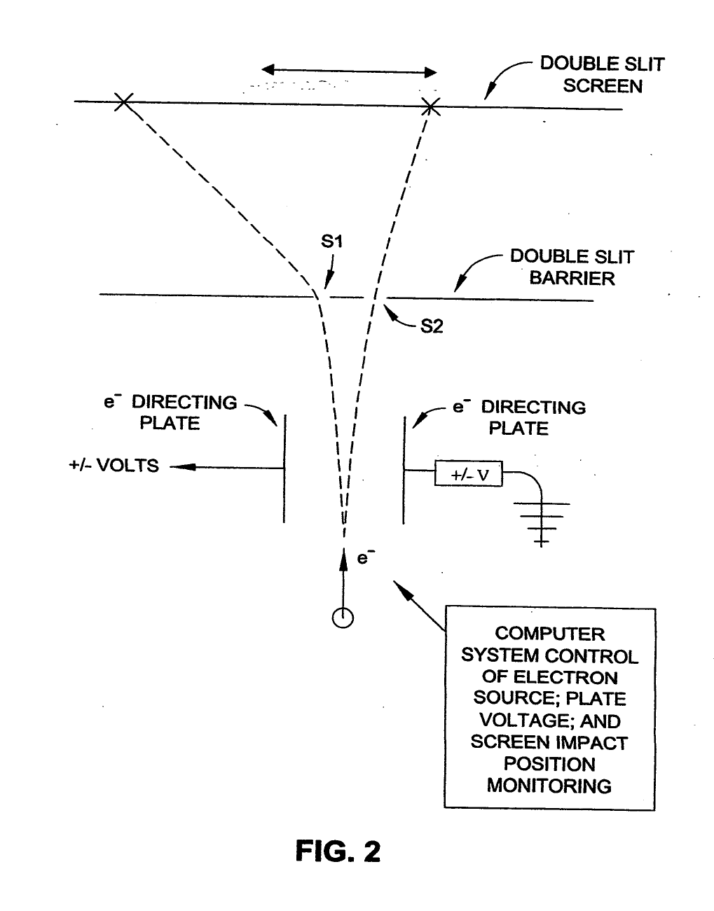

FIG. 2 shows the electron (e) directing plates as in FIG. 1 with +/−Voltage applied there-across to direct an electron passing there-between to a location within the width of a Slit (S1) (S2) of a Double Slit system. It is forwarded that where in the width of a Slit (S1) (S2) an electron passes has an effect on how it is refracted. If the electron passes near the center of a Slit, it will not be greatly refracted to either the right or left. See Slit (S2) in FIG. 2. However, if the electron passes near one edge, (ie. the right or left), of a Slit it will be refracted toward that direction as it approaches the Double Slit Screen. See Slit (S1) in FIG. 2. Note also that the FIG. 2 system can have a (+/−V) Voltage Source in the Grounded side and that said system FIG. 2 System be operated by a Computer System.

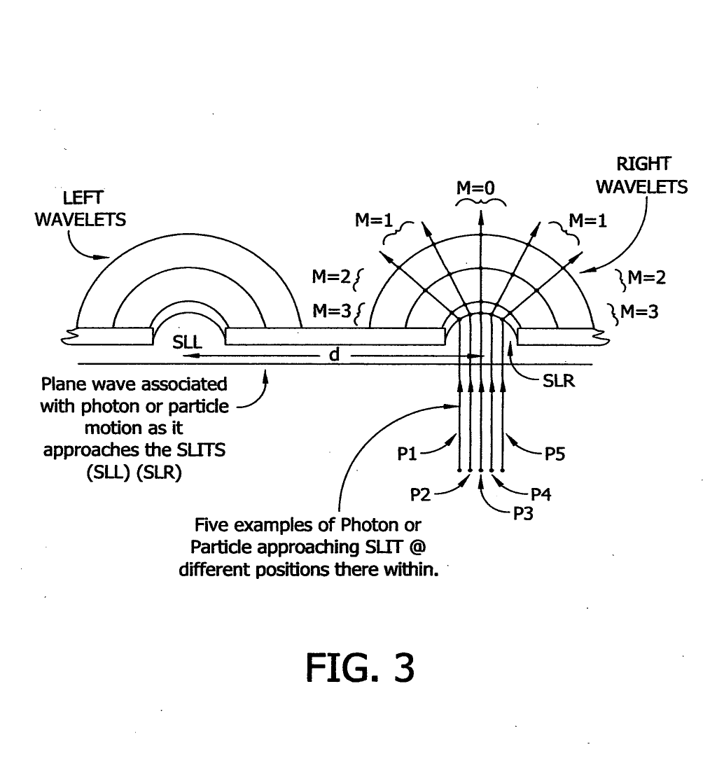

FIG. 3 is included to provide better insight as to how adjusting the potential between the electron directing plates would affect the position of the electron in the width of the Slit through which it passes. This Figure is adapted from Reference 3 identified in the Background Section. Note that Particles (P1) (P2) (P3) (P4) and (P5) are shown to enter the Right Slit (SLR) at different locations within the width thereof, and are shown being refracted so that they proceed along different trajectories that depend on the potential applied to electron directing Plates in FIG. 2.

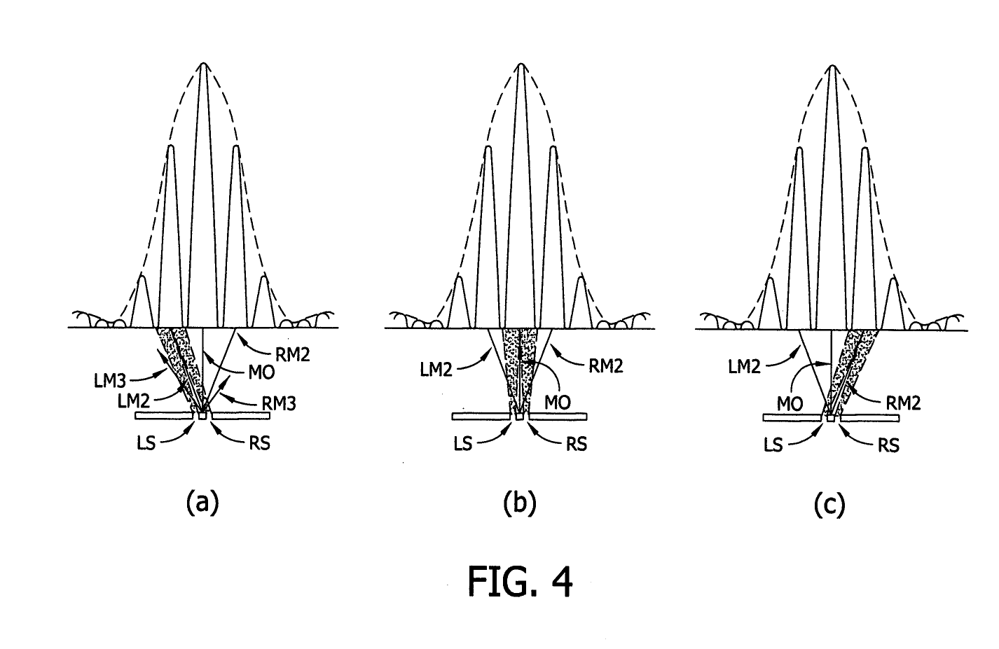

FIGS. 4a-c are included to show to what the identifier (M0), (M1) etc. refer. This Figure is also adapted from Reference 3 identified in the Background Section.

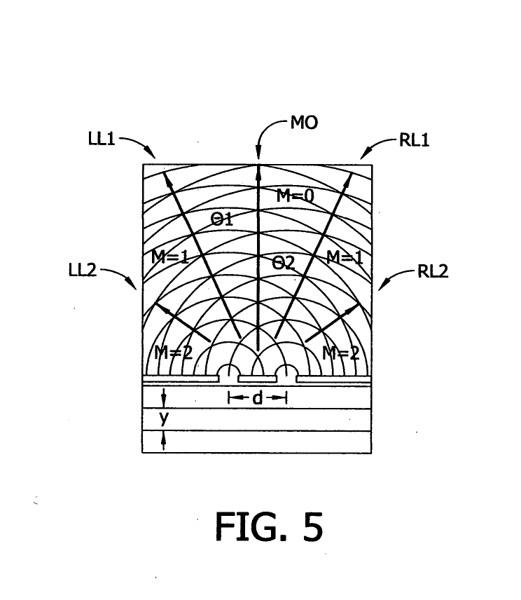

FIG. 5, also adapted from Reference 3, is included to show constructive and destructive addition of wavelets after the Slits, shown separated by a distance -d- therein. These Slits are identified as (RS) and (LS) in FIGS. 4a-c. (See Reference 3 for the meaning of identifiers (LM2) (LM3) (RM2) (RM3) and θ1 and θ2 in FIGS. 4 & 5. Said identifiers are not important for the purposes of this disclosure). This Figure is included to allow mentioning that, as the “propagation field” between the Slits and the Screen of the Double Slit system is the result of interaction between “wavelets” exiting the two Slits, based on a single, plane wave associated with the moving electron that enters them, and not the result of anything happening before the Slits, then applying a voltage to the electron Directing Plates should have no affect thereon, and therefore will not alter the results achieved based on what happens after the slits. Only where within a Slit width, and the angle at which the electron enters the “propagations field in altered by the electron directing Plate voltages.

Adapting a Double Slit System to employ a Cathode Ray Tube capability that allows an electron to be directed to a very localized position on a screen therein, (eg. an older TV set), by using plates between which an electron travels and to which are applied precise voltage potentials in use, allows controlling where within the width of a Double Slit System Slit an electron passes in use, and perhaps thereby enables predicting where on a Double Slit Screen a specific an electron will impinge as a function of the potential applied to the electron directing plates, based on determinable electron refraction characteristics.

It is noted that while electrons are used as an example herein, any charged particle can be used in the methodology. Further, it is also noted that the methodology disclosed herein, (eg. charged particle provision by the source thereof, application of voltage to the electron directing plates, and screen impact location monitoring, can be carried out under the control of a computer system.

Finally, it is to be appreciated that, as disclosed in Reference 3 in the Background Section of this Specification, (which is incorporated hereinto by reference, as are all Background Section References 1-4), that the FIG. 2 Double Slit Screen can be mounted to allow lateral motion thereof when impacted by an electron, (note double headed arrow). Knowing the electron and Double Slit Screen masses and how much the Double Slit Screen moves when impacted by an electron would then allow near simultaneous determination of the position on the Double Slit Screen at which the impact occurred and how much momentum was transferred to the Double Slit Screen as a result Combined with knowledge as to which Slit the electron was guided to pass through by the applied electron Directing Plates, a rather detailed knowledge into the “mysteries” of how the Double Slit System produces an Interference Pattern can be developed. In fact, a rather insightful “Bridge” is provided by the present invention, between voltage applied between the electron Directing Plates and the position and momentum of an electron when it impinges on the Double Slit System Screen. If fact is seems it is a “Bridge” between Classical and Quantum Physics. While perhaps not an absolute end all “Bridge”, (as there are no achievable absolutes in the physical universe), it is perhaps as close as can be achieved thereto between Classical and Quantum Physics—within the “rules” by which the physical universe operates! The inventor herein ponders—why what is disclosed herein, which is really not all that earth shattering, was not identified a very long time ago? The explanation that Quantum people seem to give is that an electron, (at well above Bose-Einstein Condensate temperatures, ie. near the theoretical absolute zero), morphs into a wave before the Slits and re-morphs back into a particle at the Double Slit Screen. Really—mass is changed into wave-energy, without it exploding, simply by placing two slits in its path of motion?

As a final point, to establish priority, it is noted that a long time friend of the Inventor herein, and even his boss for a while at Omaha Public Power District in the late 70's), Terry Pirruccello (PE), has suggested that the Double Slit Screen be made from a pressure to voltage transducer material, and then momentum could be monitored as a voltage produced thereby, when an electron impacts it. This could be applied alone, or in conjunction with a laterally movable Screen.

Having hereby disclosed the subject matter of the invention, it should be obvious that many modifications, substitutions and variations of the present invention are possible in light of the teachings. It is therefore to be understood that the present invention can be practiced other than as specifically described, and should be limited in breadth and scope only by the Claims.

I claim:

1. A method of enhancing the ability to predict where within a quantum double slit system a specific electron impacts a screen therein, comprising the steps of:
a) providing a double slit system comprising a source of electrons, a barrier having two slits therein of known widths and a screen, such that in use an electron is emitted by said source of electrons, proceeds to pass through a slit in the bather and impact the screen with the result being that an interference pattern is formed thereupon; said double slit system further comprising two plates positioned between said source of electrons and the bather having two slits therein, such that in use voltage potential s can be applied therebetween so that when an electron passes between said plates its trajectory toward the barrier containing the two slits is modified, thereby allowing its position within a slit through which it passes to be controlled;
b) while applying a known voltage potential between said plates located between said source of electrons and said bather containing two slits, causing a single electron to be emitted and directed toward said barrier containing two slits such that it passes between said two plates positioned between said source of electrons and said barrier containing two slits, such that said electron passes through a slit at a controlled location within; and impacts said screen and noting the location on said screen where it impacts;
c) repeating step b with a second electron and noting where on said screen the electron impacts;
d) comparing the results in steps b) and c).

2. A method of directing a charged particle to an impact location with a screen in a double slit system that comprises, in sequence, a source of charged particles, a barrier in which are present two slits and said screen, said method comprising, under the direction of a computer:
a) accessing a charged particle from said source thereof and causing it to approach said barrier in which are present two slits along an intended trajectory affected by causing it to pass between two charged particle directing plates, across which plates are applied a voltage;
b) allowing the charged particle to pass through one of the two double slit system slits which are present in said bather, and proceed to impact said screen; said impact location with said screen being influenced by the voltage level applied to said charged particle directing plates, and which impact location is more predictable than quantum uncertainty would allow.

3. A method as in claim 2 which further comprises, under the control of said computer, repeating steps a) and b) using a sequential plurality of charged particle with the same voltage applied between said two charged particle directing plates as was previously applied, and, using said computer comparing monitored locations as to where the charged particles in said sequential practice of said steps a) and b) impact said screen.

4. A method as in claim 3 wherein said comparison as to where the plurality of charged particles in said sequential practice of said steps a) and b) impact said screen in a grouping that is closer than would be expected by application of the uncertainty principle.

5. A system comprising a source of electrons, a barrier having two slits therein and a screen, said system further comprising two plates placed between said source of electrons and said barrier to which, in use, voltage potentials can be applied therebetween, said system components being arranged such that, in use, an electron emitted by said source thereof approaches said barrier by passing through said two plates to which a voltage potential is applied therebetween, then pass through a slit, at a position within the width thereof determined by the voltage potential applied between said plates, and impact said screen.

6. A method as in claim 4 wherein the screen is mounted so as to allow lateral motion thereof when impacted by an electron, and in which said computer is provided mass data for electrons and for the screen, and uses said mass data and a monitored amount the screen moves upon an electron impacting it, to determine, nearly simultaneously, the location upon said screen at which the impact occurred and the momentum transferred thereto to a level of certainty in excess of that allowed by the uncertainty principle.

7. A method as in claim 6 wherein if the electron contributes to a positive/negative slope region in a developing Interference Pattern, then it is more likely to have passed through the left/right slit, as viewed from the electron source.
